(19) United States
(12) Patent Application Publication
(10) Pub. No.: US 2017/0093958 A1
(43) Pub. Date: Mar. 30, 2017

(54) PUBLIC CLOUD SYSTEM AND PUBLIC RESOURCE ALLOCATION METHOD

(71) Applicant: HON HAI PRECISION INDUSTRY CO., LTD., New Taipei (TW)

(72) Inventor: YU-CHEN HUANG, New Taipei (TW)

(21) Appl. No.: 14/876,303

(22) Filed: Oct. 6, 2015

(30) Foreign Application Priority Data
Sep. 25, 2015 (TW) 104131745

(51) Int. Cl. H04L 29/08; H04L 12/911

(52) U.S. Cl. CPC H04L 67/10; H04L 47/82

(57) ABSTRACT

A management center, coupled to a plurality of data centers, which can be included in an open or public cloud computing system. The management center includes a monitoring unit and an allocation unit coupled to the monitoring unit. The monitoring unit monitors computing resources of each data center and a buying demand of a user. The allocation unit allocates computer resources of the plurality of data centers for a user according to the buying demand A public resource allocation method is also provided.

### FIELD

The subject matter herein generally relates to cloud computing.

### BACKGROUND

The services offered and hosted by cloud computing fall into a handful of categories, for example, Infrastructure-as-a-Service (IaaS), Platform-as-a-Service (PaaS), and Software-as-a-Service (SaaS).

Cloud computing has several characteristics that distinguish it from traditional hosting. It is available on demand, often by the minute or the hour. A user can have as much or as little of a service as they need or want at a time. The services provided are managed by the provider. Cloud computing owes its development to advances in virtualization and distributed computing, coupled with continually increasing opportunities for high-speed Internet access.

Public and private clouds exist, with the public clouds making computational resources available to all. In contrast, a private cloud is usually privately-owned and run and serves a limited population of users, for example the employees of a large corporation that owns the computer infrastructure. Additionally, virtual private clouds can be created from public cloud resources.

### BRIEF DESCRIPTION OF THE DRAWINGS

Implementations of the present technology will now be described, by way of example only, with reference to the attached figures.

FIG. 1 is a block diagram of an example embodiment of a public cloud system.

FIG. 2 is a flowchart of a public resource allocation method using the public cloud system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

In general, the word “unit”, as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device. The term “comprising,” when utilized, means “including, but not necessarily limited to”; it specifically indicates open-ended inclusion or membership in the so-described combination, group, series, and the like.

The present disclosure is described in relation to a public cloud system. The public cloud system includes a plurality of data centers and a management center coupled to the plurality of data centers. The management center includes a monitoring unit and an allocation unit coupled to the monitoring unit. The monitoring unit is used to monitor a computing resource of each data center and a buying demand of a user. The allocation unit is used to allocate the computer resources of the plurality of data centers for the user according to the buying demand. The disclosure further offers a public resource allocation method.

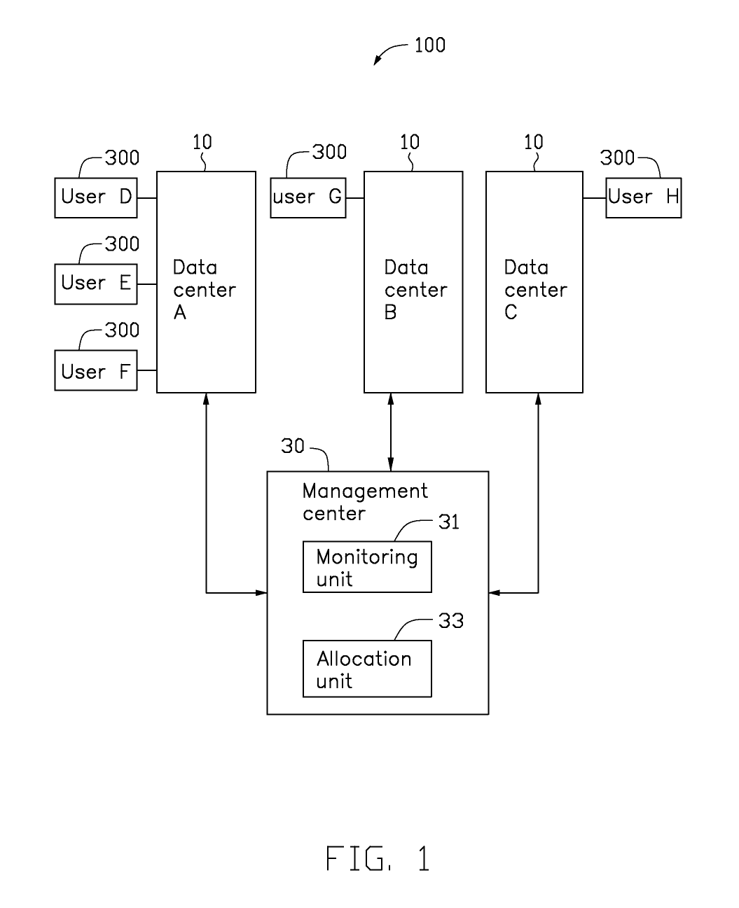

FIG. 1 illustrates an embodiment of a public cloud system 100 configured to serve a plurality of users 300. The public cloud system 100 can include a plurality of data centers 10 and a management center 30 coupled to the plurality of data centers 10. In at least one embodiment, each date center 10 can include a plurality of servers.

The plurality of data centers 10 can include a data center A, a data center B, a data center C, as illustrated. In other embodiments the number of data centers can be greater than or less than three. Each data center 10 can include computing resources. The computing resources can include a plurality of Central Processing Units (CPUs) and a plurality of memory units. In at least one embodiment, each user 300 can have a licensed data center 10 to buy the computing resource via entering into the licensed data center 10. For example, the user D, E, F can enter into the licensed data center A, the user G can enter into the licensed data center B, and the user H can enter into the licensed data center C. Thus, originally, the user D, the user E, and the user F can enter into the data center A to buy computing resources, the user G can enter into the data center B to buy computing resources, and the user H can enter into the data center C to buy computing resources.

The management center 30 can include a monitoring unit 31 and an allocation unit 33. The monitoring unit 31 is configured to monitor the computing resources of each data center 10 and a buying demand of each user 300. The computing resources can include a CPU amount, a memory amount, unused CPU capacity, and unused memory capacities. The allocation unit 33 is configured to determine whether an unused computing resource exists in the licensed data center 10 of the user 300, so that computing resources for the user 300 can be allocated by the allocation unit 33. When unused computing resource exists in the licensed data center 10 of the user 300, the allocation unit 33 can sell such unused computing resource of the licensed data center 10 for the user. When unused computing resources do not exist in the licensed data center 10 of the user 300, the allocation unit 33 can sell an unused computing resource of other data center 10 to the user 300. For example, where one-third of the computing resource of data center A is allocated to the user D, one-third of the computing resource of data center A is allocated to the user E, and one-third of the computing resource of data center A is allocated to the user F, no unused computing resources exist in the data center A. Where one half of computing resource of data center B is allocated to the user G, and one half of the computing resource of data center C is allocated to the user H, unused computer resources exist in both the data center B and the data center C. When one of the users D, E, and F wants to buy computing resource, no unused computing resources exist in the data center A, and the allocation unit 33 can allocate the unused computing resource of the data center B or of the data center C to one of users D, E, and F. When the user G wants to buy computing resource, the unused computing resources exist in the data center B, and the allocation unit 33 can allocate the unused computing resource of the data center B to the user G. When the user H wants to buy computing resource, the unused computing resources exist in the data center C, and the allocation unit 33 can allocate the unused computing resources of the data center C for the user H.

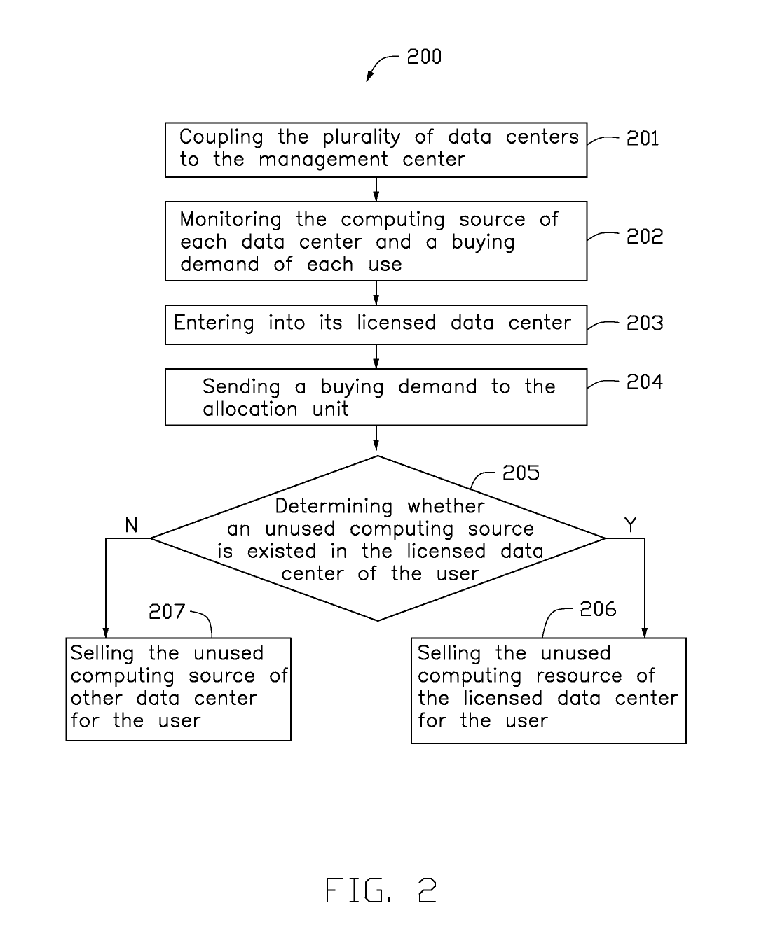

Referring to FIG. 2, a flowchart is presented in accordance with an example embodiment. The example method 200 is provided by way of example, as there are a variety of ways to carry out the method. The method 200 described below can be carried out using the configurations illustrated in FIG. 1, for example, and various elements of these figures are referenced in explaining example method 200. Each block shown in FIG. 2 represents one or more processes, methods, or subroutines, carried out in the exemplary method 200. Additionally, the illustrated order of blocks is by example only and the order of the blocks can change. The exemplary method 200 can begin at block 201.

At block 201, the plurality of data centers 10 is coupled to the management center 30.

At block 202, the monitoring unit 31 monitors the computing resources of each data center 10 and a buying demand of each user 300. The computing resources can include a plurality of Central Processing Units (CPUs) and a plurality of memory units.

At block 203, each user 300 enters into its licensed data center 10. For example, the users D, E, and F enter into the data center A, the user G enters into the data center B, and the user H enters into the data center C.

At block 204, the user 300 sends a buying demand to the allocation unit 33.

At block 205, the allocation unit 33 determines whether an unused computing resource exists in the licensed data center 10 of the user 300. If yes, process proceeds to block 206, if no, process goes to block 207.

At block 206, the allocation unit 33 sells the unused computing resource of the licensed data center 10 for the user 300. For example, one-third of the computing resource of data center A is allocated to the user D, one-third of the computing resource of data center A is allocated to the user E, and one-third of the computing resource of data center A is allocated to the user F, thus no unused computing resource exists in the data center A. One half of computing resource of data center B is allocated to the user G and one half of the computing resource of data center C is allocated to the user H, so that unused computer resource does exist in the data center B and the data center C. When one of users D, E, and F wants to buy computing resource, no unused computing resources exist in the data center A, and the allocation unit 33 can allocate the unused computing resource of the data center B or of the data center C to one of users D, E, and F.

At block 207, the allocation unit 33 can sell the unused computing resources of other data center 10 for the user 300. For example, where one-third of the computing resource of data center A is allocated to the user D, one-third of the computing resource of data center A is allocated to the user E, and one-third of the computing resource of data center A is allocated to the user F, no unused computing resource exists in the data center A. Where one half of computing resource of data center B is allocated to the user G and one half of the computing resource of data center C is allocated to the user H, unused computer resource exists in the data center B and in the data center C. When the user G wants to buy computing resource, the unused computing resources exist in the data center B, and the allocation unit 33 can allocate the unused computing resource of the data center B to user G. When the user H wants to buy computing resource, the unused computing resources exist in the data center C, and the allocation unit 33 can allocate the unused computing resource of the data center C to user H.

The embodiments shown and described above are only examples. Many details are often found in the art such as the other features of a public cloud system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A public cloud system comprising:
a plurality of data centers;
a management center coupled to the plurality of data centers and comprising:
a monitoring unit configured to monitor a computing source of each data center and buying demand of a user; and
an allocation unit coupled to the monitoring unit and configured to allocate the computer source of the plurality of data centers for the user according to the buying demand.

2. The public cloud system of claim 1, wherein the allocation unit is configured to determine whether an unused computing source is existed in a licensed data center of the user, when the unused computing source is existed in the licensed data center of the user, the allocation unit is configured to sell the unused computing source of the licensed data center for the user, and when the unused computing source is not existed in the licensed data center of the user, the allocation unit is configured to sell the unused computing source of other data center for the user.

3. The public cloud system of claim 1, wherein the computing source comprises a CPU amount, a memory amount, unused CPUs, and unused memories.

4. A public resource allocation method comprising:
(a) coupling a plurality of data centers and a management center;
(b) monitoring a computing source of each data center and a buying demand of a user by a monitoring unit; and
(c) allocating the computer source of the plurality of data centers for the user according to the buying demand by an allocating unit.

5. The public resource allocation method of claim 4, further comprising the following step: determining whether an unused computing source is existed in a licensed data center of the user by the allocating unit, when the unused computing source is existed in the licensed data center of the user, selling the unused computing source of the licensed data center for the user by the allocation unit, and when the unused computing source is not existed in the licensed data center of the user, selling the unused computing source of other data center for the user by the allocation unit.

6. The public resource allocation method of claim 4, wherein the computing source comprises a CPU amount, a memory amount, unused CPUs, and unused memories.
